(19) United States
(12) Patent Application Publication
(10) Pub. No.: US 2016/0243511 A1
(43) Pub. Date: Aug. 25, 2016

(54) NAIL POLISH SYSTEM AND KIT

(71) Applicant: Mix Your Color LLC, Scarsdale, NY (US)

(72) Inventors: JANINE AJAMIAN, New York, NY (US); Christina Nichols, Scarsdale, NY (US)

(21) Appl. No.: 14/626,334

(22) Filed: Feb. 19, 2015

(51) Int. Cl. B01F 13/10; B01F 15/02

(52) U.S. Cl. CPC B01F 13/1072; B01F 15/0227; B01F 2215/005

(57) ABSTRACT

Disclosed are methods, systems, and kits for user customizable nail polish. A base nail polish is provided in a container having headspace to allow the dropwise addition of one or more color mixer solutions to achieve a desired custom color. Kits are provided with a full range of color mixer solutions, or in smaller kits of 3-5 color mixer solutions, additional color mixer solutions may be added as well as droppers, applicators, texturizers, and top coats.

### TECHNOLOGY FIELD

The present application relates generally to methods, systems, and kits for user customizable nail polish.

### BACKGROUND

There are many types of nail polish available to users on the market. Conventional methods of selecting nail polish include providing a selection of a seemingly unlimited number of nail polish colors and selecting a nail polish from among them. The truth is there are a finite number of nail polish colors available on the shelves or in stock. These nail polish colors are created by the manufacturers, shipped to retailers, and eventually provided to the users. Accordingly, the users are limited to the number and choice of colors that are provided by the manufacturer. There is a continuing demand for more and different, as well as, customizable nail polish colors.

### SUMMARY

Some embodiments provide a system for user-customizable nail polish, the system comprising at least one base nail polish; three or more color mixer solutions, selected such that a range of mixed nail polish colors are achievable by mixing 1-40 drops of each of one or more of the three or more color mixer solutions with the base polish.

In some embodiments, each color mixer solution has a known color contribution per drop.

In some embodiments, each of the at least one base polish is independently selected from a Un-colored base polish, a mica base polish, or specially crafted base polish like a suspension base.

In some embodiments, each of the at least one base nail polish and each of the color mixer solutions are acetate based.

Some embodiments further comprise a uniform delivery device for each color mixer solution.

In some embodiments, the uniform delivery device is an eye dropper or a dropper nozzle tip.

In some embodiments, the uniform delivery device is standardized to 18-26 drops per mL of water.

Some embodiments further comprise one or more of a texturizer and a top coat.

Some embodiment further include instructions including information including which of the three or more color mixer solutions are required, and how many drops of each required color mixer solution is needed to achieve a known color.

Some embodiments provide a user customizable nail polish kit, the kit comprising a base polish in a nail polish container; a first color mixer solution; a second color mixer solution; a third color mixer solution; a fourth color mixer solution; and a themed spectrum recipe card containing information describing a spectrum of pre-established nail polish colors obtainable by mixing one or more of the first color mixer solution, second color mixer solution, third color mixer solution, fourth color mixer solution, and the base polish, and instructions for achieving each of the spectrum of pre-established colors.

In some embodiments, the base polish is a Un-colored base polish, Raw Base A; the first color mixer solution is mix no. 1; the second color mixer solution is mix no. 9; the third color mixer solution is mix no. 10; and the fourth color mixer solution is mix no. 11.

In some embodiments, the base polish is a Un-colored base polish, Raw Base A; the first color mixer solution is mix no. 1; the second color mixer solution is mix no. 3; the third color mixer solution is mix no. 4; and the fourth color mixer solution is mix no. 6.

In some embodiments, the base polish is a Un-colored base polish, Raw Base A; the first color mixer solution is mix no. 1; the second color mixer solution is mix no. 4; the third color mixer solution is mix no. 5; and the fourth color mixer solution is mix no. 8.

In some embodiments, the base polish is a Un-colored base polish, Raw Base A; the first color mixer solution is mix no. 1; the second color mixer solution is mix no. 2; the third color mixer solution is mix no. 7; and the fourth color mixer solution is mix no. 8.

In some embodiments, the base polish is a mica base polish, Raw Base A; the first color mixer solution is mix no. 1; the second color mixer solution is mix no. 2; the third color mixer solution is mix no. 5; the fourth color mixer solution is mix no. 7.

In some embodiments, the base polish is a Un-colored base polish, Raw Base A; the first color mixer solution is mix no. 1; the second color mixer solution is mix no. 2; the third color mixer solution is mix no. 3; and the fourth color mixer solution is mix no. 4.

Some embodiments provide a kit further comprising any of one or more additional color mixer solutions, one or more additional themed color spectrum recipe cards, and one or more additional color recipes.

In some embodiments, each of the color mixer solutions is housed in its own container, each color mixer solution container being provided with a uniform drop delivery device.

In some embodiments, each uniform drop delivery device is an eye dropper or a dropper nozzle tip.

In some embodiments, each uniform drop delivery device delivers a known quantity of color mixer solution, and each drop has a known color contribution.

Additional features and advantages of this disclosure will be made apparent from the following detailed description of illustrative embodiments that proceeds with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other aspects of the embodiments disclosed herein are best understood from the following detailed description when read in connection with the accompanying drawings. The drawings illustrate certain embodiments described herein and are meant to be illustrative in nature and are not meant to limit the description. Those of ordinary skill in the art will readily appreciate various additional embodiments without varying from the scope and spirit of this disclosure.

FIG. 1 illustrates a palette of 14 color mixer solutions in accordance with some embodiments described herein.

FIG. 2 illustrates a large kit in accordance with some embodiments

FIG. 3 is a table showing exemplary color mixer solutions and their composition in accordance with some embodiments.

FIG. 4 illustrates an exemplary consumer kit in accordance with some embodiments.

FIG. 5 is a table depicting exemplary themed color spectrums and corresponding bases and color mixer solutions included in a kit for a themed color spectrum.

FIG. 6 is a table illustrating exemplary colors and recipe information for themed spectrum D (sheers) in accordance with one embodiment.

FIGS. 7A-7B depict a table illustrating exemplary colors and recipe information for themed spectrum B (neutrals) in accordance with one embodiment.

FIGS. 8A-8C depict a table illustrating exemplary colors and recipe information for themed spectrum C (corals and light reds) in accordance with one embodiment.

FIG. 9 is a table illustrating exemplary colors and recipe information for themed spectrum R (clean reds) in accordance with one embodiment.

FIG. 10A-10B depict a table illustrating exemplary colors and recipe information for themed spectrum M (blues and purples) in accordance with one embodiment.

FIGS. 11A-11B depict a table illustrating exemplary colors and recipe information for themed spectrum X (mica shimmer) in accordance with one embodiment.

FIG. 12 is a table illustrating exemplary colors and recipe information for themed spectrum T (tan based) in accordance with one embodiment.

### DESCRIPTION OF EXEMPLARY EMBODIMENTS

By carefully selecting a range of nail polish items, including base polishes, a plurality of color mixer solutions, optional color mixer solutions, and optional top coats, as well as containers, droppers, and applicators thereof, a wide spectrum of finished nail polish colors, finishes, and textures can be achieved. Such variety can be achieved in the user's home, without the need for large quantities of supplies and without purchasing an endless number of nail polishes. Selectively mixing one or more of the mixer solutions with an appropriate base polish, in selected amounts, the end user can create customized nail colors.

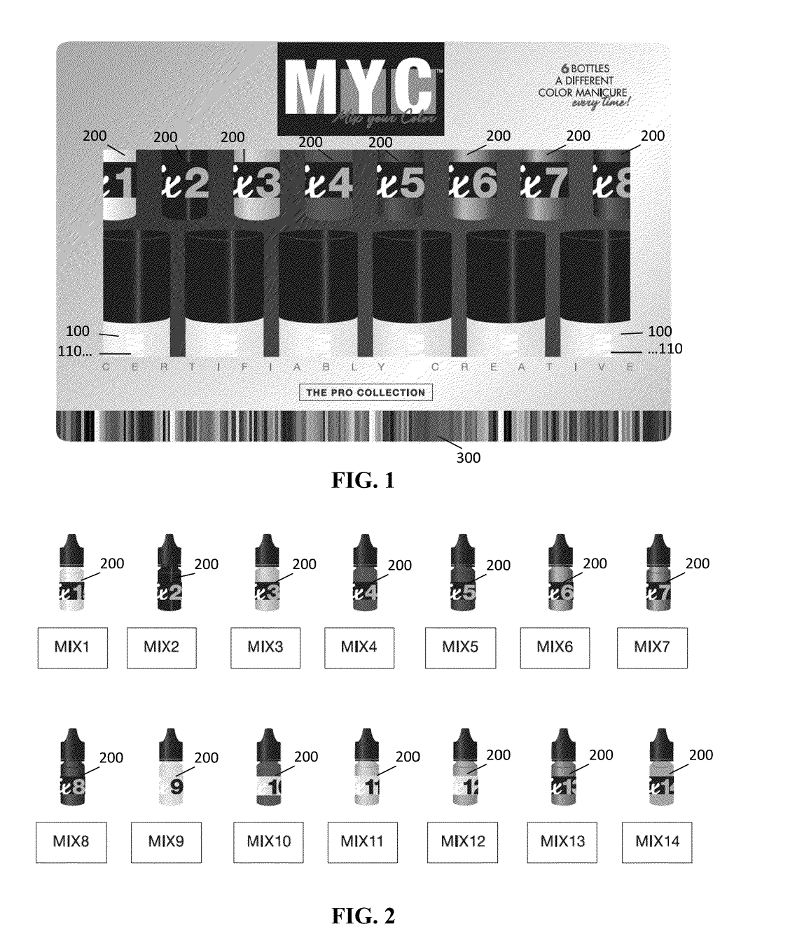

FIG. 1 illustrates an exemplary system disclosed herein. FIG. 1 depicts several nail polish containers 100, in this instance continuing a base polish 110, eight color mixer solutions 200, each in its own container, and a color spectrum 300. Each of the colors in the spectrum (and more) can be made from the combination of one or more of the color mixer solutions 200 and the base polish 110, as will be further discussed below.

### Containers and Droppers

A finished nail polish container 100 is provided for containing a finished nail polish. In some embodiments, a base polish 110 is provided and housed in the nail polish container 100 leaving headspace to allow the dropwise addition of one or more color mixer solutions 200. In other embodiments, the base polish 110 may be provided separately and added along with one or more color mixer solutions 200 to an empty nail polish container 100 to make a mixed nail polish.

As is customary with nail polish, the container may be glass, plastic, or other suitable material and may contain steel ball bearings to facilitate mixing upon shaking Two ball bearings are standard in the industry, although more may be used. The finished nail polish container may also include a cap with an included applicator brush. Because kits including the nail polish items may include pre-determined mixing instructions and ratios, some embodiments provide a nail polish container 100 of a known volume, and containing a known volume of base polish 110. For example, in some embodiments, a 10 mL container will contain about 7.5 mL base polish, which is a typical size for commercially available nail polishes. Some embodiments may contain between about 5 mL and about 9 mL of base polish. In some embodiments, a 10 mL container will contain about 5 mL, about 5.25 mL, about 5.5 mL, about 5.75 mL, about 6 mL, about 6.25 mL, about 6.5 mL, about 6.75 mL, about 7 mL, about 7.25 mL, about 7.5 mL, about 7.75 mL, about 8 mL, about 8.25 mL, about 8.5 mL, about 8.75 mL, about 9 mL, or any value or range of values between any two of the recited values of base polish. The extra headspace in the container allows for customization via the controlled, dropwise addition of one or more color mixer solutions. It is contemplated that larger containers may be used to produce more of the same customized color. For example, a larger container may be desirable when mixing a custom color for a bridal party. The mixing ratios remain the same. Mixing one large batch as opposed to several smaller batches will ensure uniformity from one bridesmaid to the next. On the other hand, smaller quantities may also be used, say for gifting or extracting a particular color to save.

Each of the color mixer solutions will be provided in a container. Any suitable container will suffice in any size, but for practical purposes a size similar to a standard nail polish container is suitable for regular consumer applications. A uniform drop delivery device is provided either as part of a cap for each color mixer solution container, or as a separate dropper. The drop delivery device may also be incorporated as a nozzle on the color mixer solution container itself (e.g. a dropper nozzle tip with cap, as shown in FIG. 2). The drop delivery device may be any suitable device used for delivering liquid products in a dropwise manner.

The size of drops delivered by a drop delivery device depend upon a number of factors, including size and shape of the drop delivery device and its dispensing aperture, as well as the viscosity, surface tension, temperature, and other properties of the product being dispensed. Thus, through a combination of drop delivery device size and shape and product properties, standard drop sizes can be achieved. Some deliver drops similar to standard eye droppers, which require 18-26 drops per mL of water. (Water is used as a standardized test solution when evaluating drop consistency). In some embodiments, drop sizes of about 20 drops per mL of water are used. To ensure proper ratios of color mixer solutions in the final nail polish color, the drop delivery device for each color mixer solution should deliver relatively uniformly sized drops, from drop to drop, and from one drop delivery device to the next.

In some embodiments, the drop delivery device dispenses about 0.01 and 0.03 mL per drop. In some embodiments, the drop delivery device dispenses about 0.01 mL, 0.02 mL, 0.03 mL, 0.04 mL, 0.05 mL and any range of values between any two of these values. Alternatively, different drop delivery devices may be used to account for the color changing effect of a given color mixer solution. That is, if a certain color mixer is shown to provide, for example, too much color, a different drop delivery device could be used to deliver smaller drops. Likewise, where a larger drop is required, a larger drop delivery device may be used. In any event, the color changing effect of a single drop of a particular color should be consistent from drop to drop.

### Polish

Nail polish generally includes four major types of ingredients: solvents, film forming agents (polymers), resins/plasticizers, and pigments. Additional ingredients may be used for various reasons.

Usually the most abundant ingredient in a polish is the solvent. Solvents are added to the mix of other ingredients to create a uniform product and help products flow smoothly which aid spreadability. Solvents also aid in preventing pigments from settling out. Solvents are liquids, such as ethyl acetate, butyl acetate, and various alcohols. They, in part, determine how thick a polish is and how long it takes for the polish to dry. Solvents keep the remaining ingredients consistently dissolved in the polish during application, then slowly evaporate away after the polish has been applied. To achieve desired evaporation times and other properties, a combination of solvents may be used.

Some common solvents that may be employed in the nail polish systems described herein include, but are not limited to ethyl alcohol, isopropyl alcohol, ethyl acetate, butyl acetate, ethyl acetate, butyl acetate, propyl acetate, stearalkonium hectorite, and stearalkonium bentonite and combinations thereof. Ethyl acetate and butyl acetate are often used together.

Film forming agents (sometimes referred to as primary film formers), such as, but not limited to, nitrocellulose, create a film that binds the other nail polish ingredients together and produces a film, which allows the nail polish to dry evenly. Other attributes imparted by film forming agents include one or more of durability, toughness, solubility, and quick solvent release under ambient drying conditions. Film forming agents, and nitrocellulose specifically, come in different viscosities where thinner viscosities dry faster but are more susceptible to chipping/cracking and thicker viscosities take longer to dry but last longer and produce higher shine. Often the choice of film forming agent(s) and their viscosities is often a compromise between these characteristics. Combinations of various film forming agents and viscosities may be used. Film formers, such as nitrocellulose, can by themselves be brittle and may not adhere well to nails. To combat this, they are often combined with one or more resin and/or plasticizer.

Resins and plasticizers (sometimes referred to as secondary film formers) are used to modify the film and enhance its properties. A resin or plasticizer, or combination thereof, may be used to modify the primary film former to be more flexible, to allow polish to be applied without drying too quickly, or to improve the evenness of application on the nail. Use of resins and/or plasticizers improved durability, adhesion, and resilience of the polish. Resins are the sticky components that adhere the film to the nail. Resins are used to modify the film and enhance its properties. Resins add gloss and hardness to the film of the nail polish. Plasticizers provide flexibility for the polish to prevent it from cracking and chipping, while creating resistance from soap and water to ensure a longer-lasting manicure. Plasticizers are also important to base coats which make the nail polish less prone to chipping.

Examples of plasticizer/resins include, but are not limited to, camphor, stearate esters, other fatty acids, and castor oil, Acetyl Tributyl Citrate, Acetyl Triethyl Citrate, Acetyl Trihexyl Citrate, and Acetyl Triethylhexyl Citrate, Trimethylpentanediyl Dibenzoate, Acrylates Copolymer, Ether Acrylates Copolymers, and Polymers of acrylic acid (and its salts).

Acrylates Copolymer is a general term for copolymers of two or more monomers consisting of acrylic acid, methacrylic acid or one of their simple esters. Other copolymers of acrylic acid and other monomers: Ammonium Acrylates Copolymer, Ammonium VA/Acrylates Copolymer, Sodium Acrylates Copolymer, Ethylene/Acrylic Acid Copolymer, Ethylene/Calcium Acrylate Copolymer, Ethylene/Magnesium Acrylate Copolymer, Ethylene/Sodium Acrylate Copolymer, Ethylene/Zinc Acrylate Copolymer, Ethylene/Acrylic Acid/VA Copolymer, Acrylates/VP Copolymer, Acrylates/VA Copolymer, Steareth-10 Allyl.

Ether Acrylates Copolymers are similar to Acrylates Copolymer and can be used with or instead of acrylate copolymers. Examples include: Acrylates/Steareth-50 Acrylate Copolymer, Acrylates/Steareth-20 Methacrylate Copolymer, Acrylates/Ammonium Methacrylate Copolymer, Styrene/Acrylates Copolymer, Styrene/Acrylates/Ammonium Methacrylate Copolymer, Ammonium Styrene/Acrylates Copolymer, Sodium Styrene/Acrylates Copolymer, Acrylates/Hydroxyesters Acrylates Copolymer, Methacryloyl Ethyl Betaine/Acrylates Copolymer, Lauryl Acrylate/VA Copolymer, VA/Butyl Maleate/Isobornyl Acrylate Copolymer, Ethylene/Methacrylate Copolymer, Vinyl Caprolactam/VP/Dimethylaminoethyl Methacrylate Copolymer, Sodium Acrylates/Acrolein Copolymer, VP/Dimethylaminoethylmethacrylate Copolymer, AMP-Acrylates Copolymer.

Polymers of acrylic acid (and its salts) also have similar properties and functions. Some examples include: Polyacrylic Acid, Ammonium Polyacrylate, Potassium Aluminum Polyacrylate, Potassium Polyacrylate, Sodium Polyacrylate.

Coloring pigments are added after the resins and/or plasticizers are combined together with the primary film former. A combination of naturally occurring and manufactured pigments are blended together to create varying shades and colors. Many FDA approved pigments will not bind to or mix with the other nail polish ingredients on their own. Manufacturers use solvents, discussed above, to help bind the pigments together, and to allow the pigments to blend with the other ingredients. The primary purpose of the pigments is to add color. These solvents help keep all of the ingredients blended and uniform, giving the nail polish a smooth appearance when applied to the nail.

Exemplary pigments include Titanium Dioxide, ferric ferrocyanide, stannic oxide, carmine, ultramarine, manganese violet, FD & C Red #6 Barium Lake, FD & C Red #7 Calcium Lake, FD & C Yellow #5 Aluminum Lake, CI 777266, CI 77891, CI 15880, and others.

In addition, other additives that affect appearance but are not strictly pigments may also be used alone or in combination with one or more pigments. For example, pearlescent minerals such as ground mica (a mineral) and plastic chunks of glitter are included in some nail polishes to create an iridescent and shimmery effect. Although the appearance altering additives could be included in one or more color mixer solutions, keeping them separate allows greater flexibility for the color mixer solutions. One or more optional ingredients may be used to impart desirable characteristics to any or all of the base polishes, color mixer solutions, and top coats. Ingredients such as suspension agents, thickening agents, stabilizers, drying agents, etc. and combinations thereof may be employed. Suspension agents may be used to limit rapid settling of pigments and other ingredients. Suspension agents are particularly helpful in polishes including mica, glitter, or other larger particles. Thickening agents may be added to control flow during application and/or facilitate the dispersion of solids in liquids. Stabilizers, such as the UV-absorber benzophenone may be used to inhibit the polish from changing color in bottle. A drying agent such as dimethicone can be used to speed the drying of nail polish.

Exemplary additives which may be used alone or in combination with one another are detailed below. Mica is an opalescent pigment that gives a shimmery look. Bismuth Oxychloride is a special effect pigment that adds a pearlescent shimmer. Silica is a thickening agent that prevents premature settling of pigments and lowers the gloss of polish. Titanium Dioxide is used to increase the opacity or “coverage” of polish (opacifying agent) also used as a white pigment (colorant). Citric Acid is a stabilizing agent used to control the color of the pigment. In the systems described herein, pigments are generally found in the color mixer solutions, rather than in a base polish. The other ingredients may be found in either or both of the color mixer solutions and the bases. Each are formulated such that their combination yields a finished polish having desirable characteristics including any or all of good adherence, durability, shine, etc.

### Base Polish

Base polishes may include a Un-colored base polish or a colored base polish including any of the ingredients described above. In some embodiments, the base is provided with additional components to provide texture or shimmer. The base may further include one or more color components to make a colored base. In some embodiments, the base polish is white. In some embodiments, a Un-colored base is used, that is, no pigment is added, although the base may have some color on its own, generally it is thought of as clear or colorless. This allows for the greatest flexibility in developing mixtures.

Water based and solvent based polishes are known in the art, and may be used in accordance with the teaching herein. The industry, however, favors solvent based polishes, and acetate based polishes in particular. In some embodiments, the base polish is an acetate based polish. Other base components may be added to achieve desirable base polish properties, such as but not limited to working time, drying time, hardness, viscosity, mixability, and other properties of nail polish. Typical base components include, but are not limited to one or more of butyl acetate, ethyl acetate, nitrocellulose, adipic acid/neopentyl glycol/trimellitic anhydride copolymer, acetyl tributyl citrate, isopropyl alcohol, steralkonium bentonite, acrylates copolymer, styrene/acrylates copolymer, silica, benzophenone-1, trimethylpentanediyl dibenzoate.

Exemplary Un-Colored Base a

| Ingredient | % |
|---|---|
| Butyl acetate | 40.0 |
| Ethyl acetate | 22.55 |
| Nitrocellulose | 14.0 |
| Adipic acid/neopentyl glycol/trimellitic | 7.1250 |
| anhydride copolymer | |
| Acetyl tributyl citrate | 7 |
| Isopropyl alcohol | 6 |
| Steralkonium bentonite | 1.2 |
| Acrylates copolymer | 0.5 |
| Styrene/acrylates copolymer | 1.125 |
| Silica | 0.2 |
| Benzophenone-1 | 0.2 |
| Trimethylpentanediyl dibenzoate | 0.1 |

Exemplary Mica Base (Medium Mica A)

Some embodiments may use a base polish including mica to achieve a shimmery appearance. In these embodiments, a measured portion of mica is added to a base polish. For example, mica may be added from about 0.5% to about 5%. For medium mica base such as exemplified above, from about 1% to about 2.5% mica may be used. For a light mica base, about 0.5% to about 1% mica may be used. For a heavy mica base, about 2.5% to about 5%. An exemplary medium mica base includes:

Exemplary Medium Mica (Medium Mica A)

| Ingredient | % |
|---|---|
| Butyl acetate | 39.2 |
| Ethyl acetate | 22.090 |
| Nitrocellulose | 13.72 |
| Adipic acid/neopentyl glycol/trimellitic | 6.9825 |
| anhydride copolymer | |
| Acetyl tributyl citrate | 6.86 |
| Isopropyl alcohol | 5.88 |
| Mica | 1.74 |
| Stearalkonium bentonite | 1.176 |
| Acrylates copolymer | 1.1025 |
| Styrene/acrylates copolymer | 0.49 |
| Titanium dioxide | 0.26 |
| Silica | 0.196 |
| Benzophenone-1 | 0.196 |
| Trimethylpentanediyl dibenzoate | 0.098 |

More or less mica or additional components may be added to achieve the desired effect. (Other materials can replace mica for different effect, for example, Metalure may be used to achieve a metallic look.)

### Color Mixer Solutions

A plurality of color mixer solutions is also provided. Each of the plurality of color mixer solutions will be compatible with the selected base polish, for example, each of the color mixer solutions may be acetate based if the base polish is acetate based. Each of the plurality of color mixer solutions has a particular, and known, color and saturation profile. From these, each color mixer solution will have a known color contribution. That is, with the known color and saturation profile and a known drop size, the color contribution of a drop of the color mixer solution will be known. Each color mixer solution may be either a fully saturated color solution, or a dilute color solution.

The color mixer solutions are chosen and formulated such that a suitable color change can be made through dropwise addition to the base (or base containing the dropwise addition of one or more other color mixer solutions). Although any number of colors may be used, it has been found that 3-5 color mixer solutions provide a good balance between choice of colors, ease of use, and vibrancy. For ease of use, the color mixer solutions are chosen to have a desirable color effect when used at less than 50 drops per color mixer solution. In some embodiments, less than 30 drops are used. In some embodiments, less than 20 drops are used.

A fully saturated color solution generally is considered 100% saturated, and has a maximum effect on driving color change when added to the base polish during the mixing process. Using fully saturated colors allows for a single drop to drive a color change in the base polish or partially mixed polish. Dilute color solutions may be desirable to effect a more subtle change.

A particular dilute color solution may be a chemical dilution of a fully saturated color or a new composition designed to achieve a less significant effect on color change than a fully saturated solution.

A chemical dilution of a fully saturated color solution may be made at any suitable dilution factor including, but not limited about 1%, about 5%, about 10%, about 15%, about 20%, about 25%, about 50%, about 75%, about 80%, about 85%, about 90%, about 95% or any value or range of values between any of these values. In some embodiments, a diluted color mixer solution is diluted to about 10% of the fully saturated color. These chemical dilutions are typically made by adding non-color compounds to the solution. One drop of such a 10% color solution will have much less (e.g., 10%) impact in driving a color change than a fully saturated solution. In some embodiments, the dilution brings about a color change not described as a simple diluted color. For example, in some instances, a dilution of “black” may appear bluish or purple rather than a “lighter” black.

In alternative dilute color solutions, the solution is not a strict dilution of an existing color mixer solution, but rather a different composition designed to achieve a diluted effect. For example, a dilute solution may be made up simply of ethyl acetate and a color compound. The effect of the dilute color mixer solution is designed to be less than that of a fully saturated color mixer solution. In some embodiments, the effect is designed to be about 10% of a full color mixer solution. In some embodiments, the effect is about 15%, 20%, 25%, 30%, 50%, 60%, 75% or any value or range of values between any of these values.

Regardless of whether the dilute color mixer solution is a chemical dilution or a different composition, the desired effect is that the dilute color mixer solution will not drive as dramatic an effect as a fully saturated color solution. In some embodiments, 10 drops of a dilute solution would drive the same color change as a single drop of a fully saturated color mixer solution. This is considered a 10% dilution.

Both fully saturated and diluted color mixer solutions will be available in a variety of colors. In some embodiments, the number and choice of colors are selected to achieve a wide array of particular and known colors through various combinations, as well as an infinity of custom colors made by random additions of colors.

In the embodiments discussed herein, each of the color mixer solutions is acetate based. In connection with the acetate base described above, the color mixer solutions include, but are not limited to one or more of butyl acetate, ethyl acetate, nitrocellulose, adipic acid/neopentyl glycol/trimellitic anhydride copolymer, acetyl tributyl citrate, isopropyl alcohol, steralkonium bentonite, acrylates copolymer, styrene/acrylates copolymer, silica, benzophenone-1, trimethylpentanediyl dibenzoate. For pigmentation, any suitable colorants may be used. For example, one or more of yellow 5 lake, red 6 lake, ferric ammonium ferrocyanide, titanium dioxide, black 2, yellow 5 lake, red 6 lake, stearlkonium bentonite, ultramarines, red 34 lake, steralkonium hectorite, red 7 lake, and combinations thereof maybe used. These colorants are readily available for making custom color mixer solutions, or off the shelf colorants may be used.

For the color mixer solutions described herein, colors from Fiabila (Linden, N.J.) were evaluated and used to provide several color mixer solutions. In some instances, off the shelf color solutions can be used; in others, custom solutions and modifications were made to obtain the desired color changing effect and/or other property. It should be noted that the system and kits are not limited to these particular colors or color mixer solutions.

### Kits

The plurality of colors available as color mixer solutions may be a range of colors and dilutions from 4 to an endless number of colors, or in practical embodiments, from 4 to 40, from 4 to 30, from 4 to 25, from 4 to 30, from 4 to 15 different colors and dilutions. For example, in a professional set, a large number of colors (10 or more) allows the greatest flexibility for a salon owner to create specific colors for a wide variety of customers, and may span two or more themed color spectrums. On the other hand, through careful selection of a limited number of colors and dilutions, a surprising array of colors can be created for the non-professional. For professional use (or for consumers who like to have maximum flexibility), an enormous range and variety of nail polish colors can be achieved from a kit of 14 color mixer solutions, including 10 fully saturated color mixer solutions, and 4 diluted color mixer solutions. Of course, even larger numbers of color mixer solutions can be used to increase the number of colors and/or palettes achievable. For home use, kits are selected using fewer color mixer solutions from the larger palette. In themed kits, typically 3-5, and in some embodiments 4, different color mixer solutions will be provided in addition to one or more base polishes.

Optional color mixer solutions may also be provided. These may be added to kits of known color mixer solution combinations to enhance and/or expand the colors achievable from the kit. The optional color mixer solutions may be specialty color mixes (e.g. holiday colors) or may be an additional color mixer solution from the larger color palette added to enhance a particular themed spectrum. These may be fully saturated or diluted color mixer solutions.

### Full Color Mixer Solution Series

In one embodiment, a full series includes the option of an uncolored polish or a mica base polish, or bottles of both, as well as a plurality of color mixer solutions (those that are found in smaller kits), one or more optional color mixer solutions (not necessarily found in a kit), optional texturizers, optional top coats, etc. (It should be recognized that more or less different combinations of bases, color mixer solutions, and top coats may be put in the series. The description is exemplary only. FIG. 2 shows an exemplary series of color mixer solutions and optional color mixer solutions.

From the plurality of color mixer solutions and optional non-kit color mixer solutions, a wide variety of colors may be made. The color mixers include fully saturated color mixer solutions and diluted color mixer solutions (about 10% saturation). The color mixer solutions may be grouped into smaller kits to provide a themed spectrum as discussed further below. Optional color mixer solutions can be thought of as non-kit color mixer solutions, since they are added onto kits to add to the available colors that can be made. FIG. 2 depicts individual bottles that may be in such a large kit, including saturated color mixer solutions (denoted 1-8, 13 and 14) with a black label, diluted color mixer solutions, (denoted here 9-12) with a silver (or grey) label.

Any kit including a full series kit, a pro kit, or a themed spectrum kit will include one or more charts showing colors. Although the color spectrum attempts to capture as many potential colors as possible, it should be clear that there is an infinite variety of colors that can be achieved and that similar colors can be achieved by different routes. In some embodiments, each color presented in the color spectrum represents a color for which there is a predetermined recipe corresponding to base, type of color mixer solution, and the number of drops of each color mixer solution used. The kit shown in FIG. 1 also shows an exemplary “Pro-kit” having eight color mixer solutions and two bases as well as a color spectrum having exemplary colors that may be made from the included eight color mixer solutions. This list is included in some embodiments, with instructions telling the end user how to create each desired color.

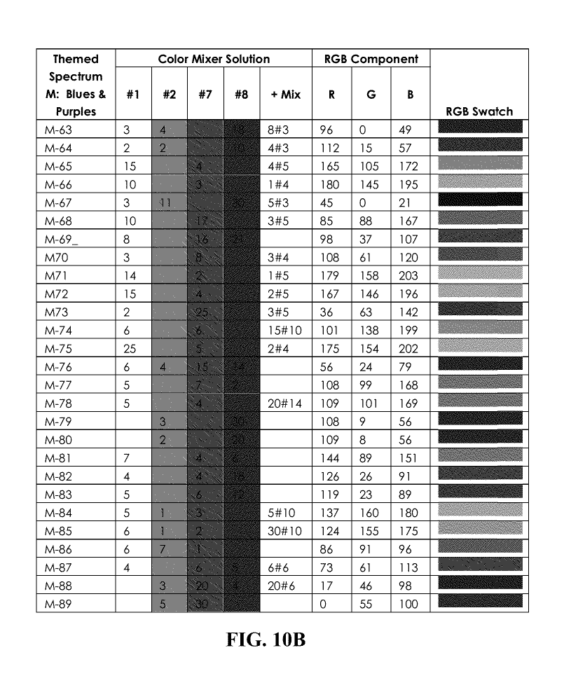

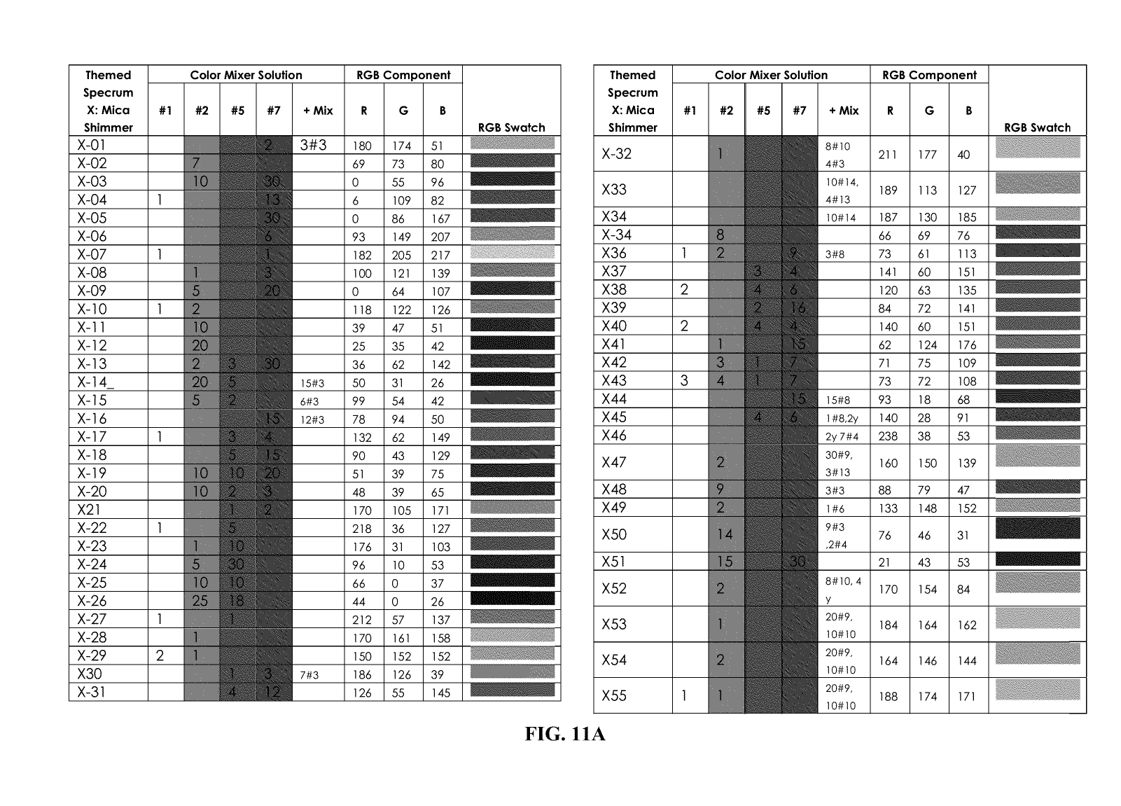

Additional top or finish coats may also be provided as part of a complete and complex series or as part of smaller kits, or as add on treatments. As shown, in FIG. 10, such finishes as matte, satin, pearl, etc. may be used.

Each of the color mixer solutions is an acetate based composition and was chosen for its color profile, saturation, and for its intractability with the other colors. These specific colors and color formulations were chosen because they allow for a wide range of colors and for ease of mixability.

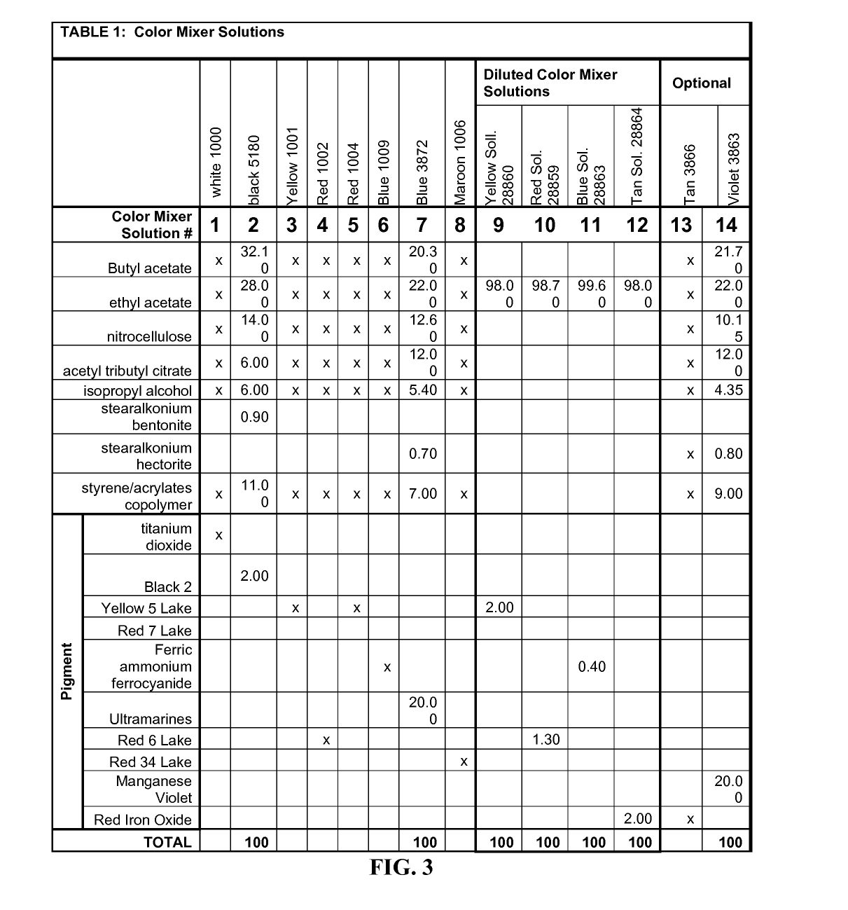

Color mixer solutions 1-14 as described herein and shown in FIG. 2 are listed in the table shown in FIG. 3.

As noted above, these color mixer solutions are exemplary only. Any combination of specific colors, and any suitable compositional make-up of the individual color mixers may be used consistent with the teachings herein.

### Themed Spectrum Kits

Although it is contemplated herein that an individual or a professional may wish to obtain and use the entire range of color mixer solutions, as alluded to above, some embodiments involve the use of a limited number of carefully selected color mixer solutions in combination with a base polish to achieve a themed spectrum of colors. In some embodiments, the limited number of selected color mixer solutions in a particular kit ranges from 3 to 5. In some embodiments, 4 color mixer solutions in containers are provided in a kit which also contains a base polish in its own container. In some cases, the base polish is contained in a finish nail polish container with head space sufficient to allow addition of several drops of one or more of the provided color mixer solutions. In some embodiments, an optional fifth color mixer solution may be added. Because the nail polish will be mixed at home by the consumer, it is believed that this limited number of color mixer solutions provides the best balance between choice of colors, and ease of use. Additionally, limiting the number of color mixer solutions added to the final nail polish allows the colors to remain vibrant and bright. The use of too many colors may lead to a dull or muddy appearance (and may create a polish that is too thick). The addition of many colors also may increase the total volume, leading to larger container sizes or reducing the amount of base polish.

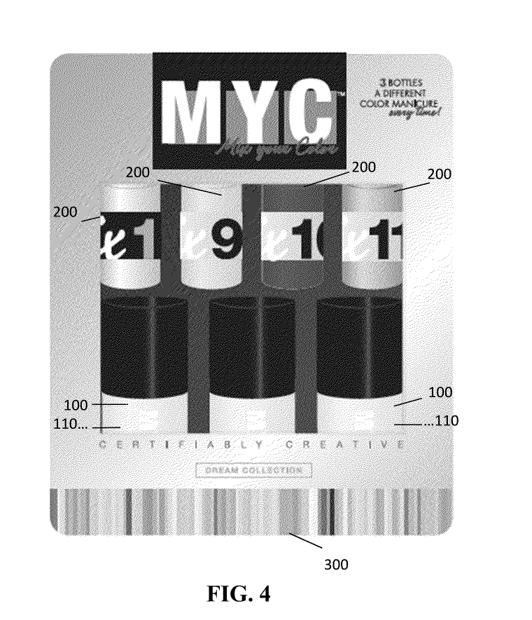

Some embodiments employ a 10 mL container housing 7.75 mL of base polish, to which up to 50 drops of a plurality of color mixer solutions may be added (assuming a standard drop size of 20 drops/mL). Of course, larger bottles may be used to allow greater volume of nail polish and to permit more base and/or color mixer solution drops. In some embodiments, the plurality of color mixer solutions is from 3-5. In some embodiments, the plurality of color mixer solutions is 4 or 5. In some embodiments, the plurality of color mixer solutions is 4. In some embodiments, each of the plurality of mixer solutions is selected from a larger set of mixer solutions. A generic kit containing a finished polish container 100 with base polish 110, four color mixer solutions, and a color spectrum 500 is depicted in FIG. 4.

### Themed Spectrums

In a four color kit, a wide variety of final nail polish colors may be achieved. Some of the colors achieved even seem impossible to achieve from the original color set, but due to mixing and dilution effects, a wide array of colors can be achieved.

The color variation is most easily thought of, and achieved, in collections, which we have called themed color spectrums. Through combination of a base polish and four specifically selected color mixer solutions, a wide range of colors within a themed color spectrum can be achieved. Although certain combinations are described herein, we are not limited to these themes. In fact, it is specifically contemplated that additional combinations will and can be made taking into account current and future trends. In this manner, the manufacturer can develop and present new and exciting themed color spectrums to consumers, without requiring a complete new set of color mixer solutions, or requiring new mixing, labeling at the factory, or by allowing consumers to supplement kits they already own. Exemplary themed color spectrums include sheers, neutrals, coral and pale reds, clean reds, blues and purples, shimmer, and various other palettes.

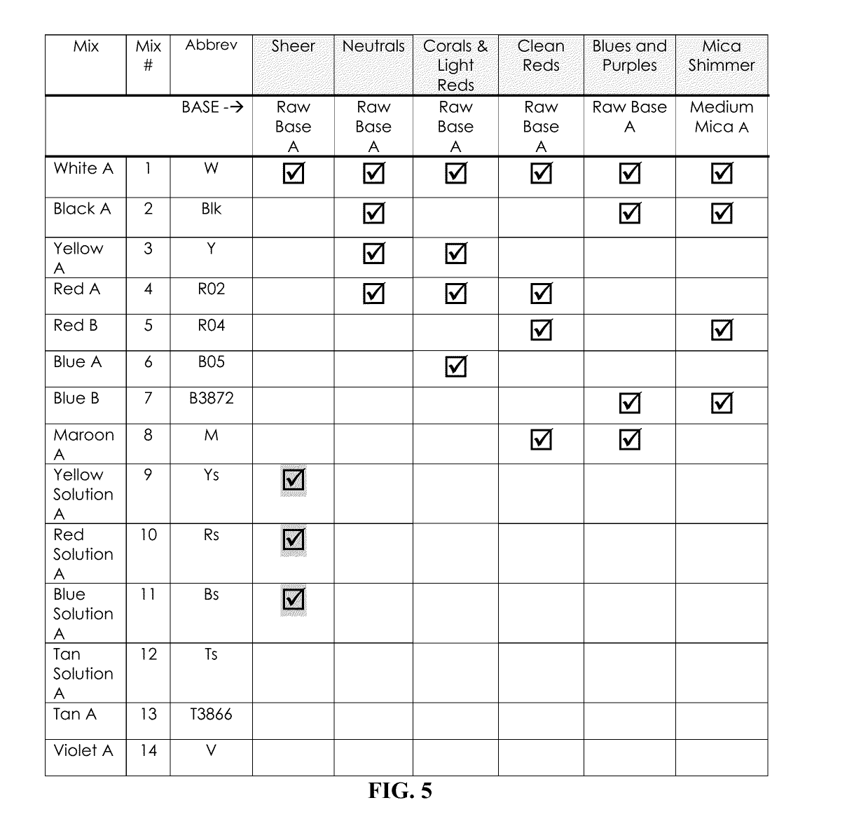

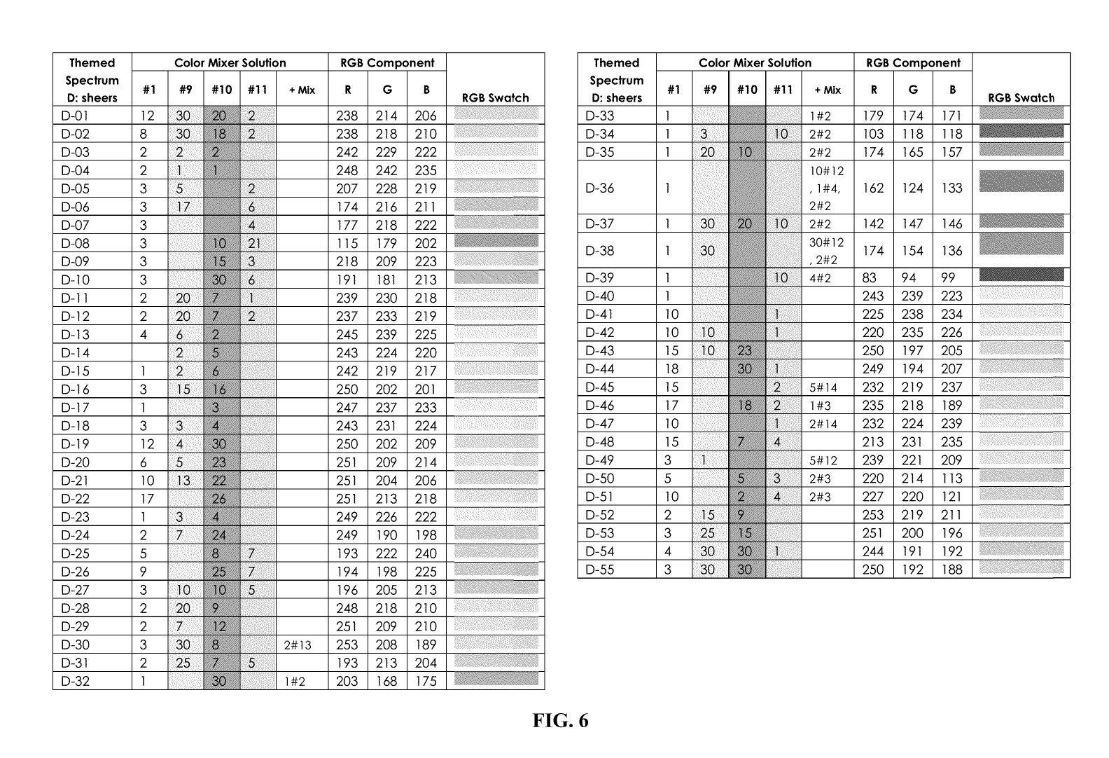

FIG. 5 is a Table showing which of the bases and which of the color mixer solutions are used in several themed color spectrums described herein. Each of FIGS. 6-12 (discussed further below) shows the mixer solutions included in each kit, the number of drops of each color mixer solution needed for a particular desired color, the number and color of any optional color mixer solutions needed, the RGB components of the resultant color, and a color image of the color.

The number in each column for the color mixer solutions represents the number of drops required of that color mixer solution. In the +Mixer column, the number of drops precedes the number of the optional mixer solution required. In the figures, 6#12 means the color requires the addition of 6 drops of color mixer solution #12, in addition to the drops of the color mixer solutions provided in the kits. The RGB component information is provided, so that the desired color can be described herein, even if the color does not show. RGB components can be input into standard RGB calculation software, such as found at http://www.colorspire.com/rgb-color-wheel/

Themed Spectrum D: Sheers (Dream On)

From the base polish and color mixer solutions described above, a kit is provided, such as shown in FIG. 4, with a 10 mL nail polish container 100 containing 7.75 mL Un-colored base polish 110, a container containing color mixer solution #1, a container containing color mixer solution #9, a container containing color mixer solution #10, and a container containing color mixer solution #11. A spectrum card 500 is also provided with a number of predetermined colors that may be achieved from this kit. Each color is given a recipe indicating how many drops of each color mixer solution is needed to achieve the desired color. Each of the color mixer solution containers is provided with a dropper of uniform size and shape to deliver uniform drops from one solution to the next. FIG. 6 is a table depicting the themed spectrum and some of the colors achievable from this kit. The chart shows the relative number of drops of each color mixer solution to be added to the base polish to achieve the desired final nail polish color.

It should be readily recognized that additional colors or variations of these colors are possible by manipulating the relative proportions (drops) of each of the color mixer solutions. Additionally, as described above, additional colors are possible by adding a fifth, optional color mixer solution. (The user, of course, is free to add as many as they wish. Four or five colors maintains a level of brightness that could be lost with more colors.) The additional color mixer solution may be provided in the kit, or made available as an add-on.

Themed Spectrum B: The Neutrals (Bare all)

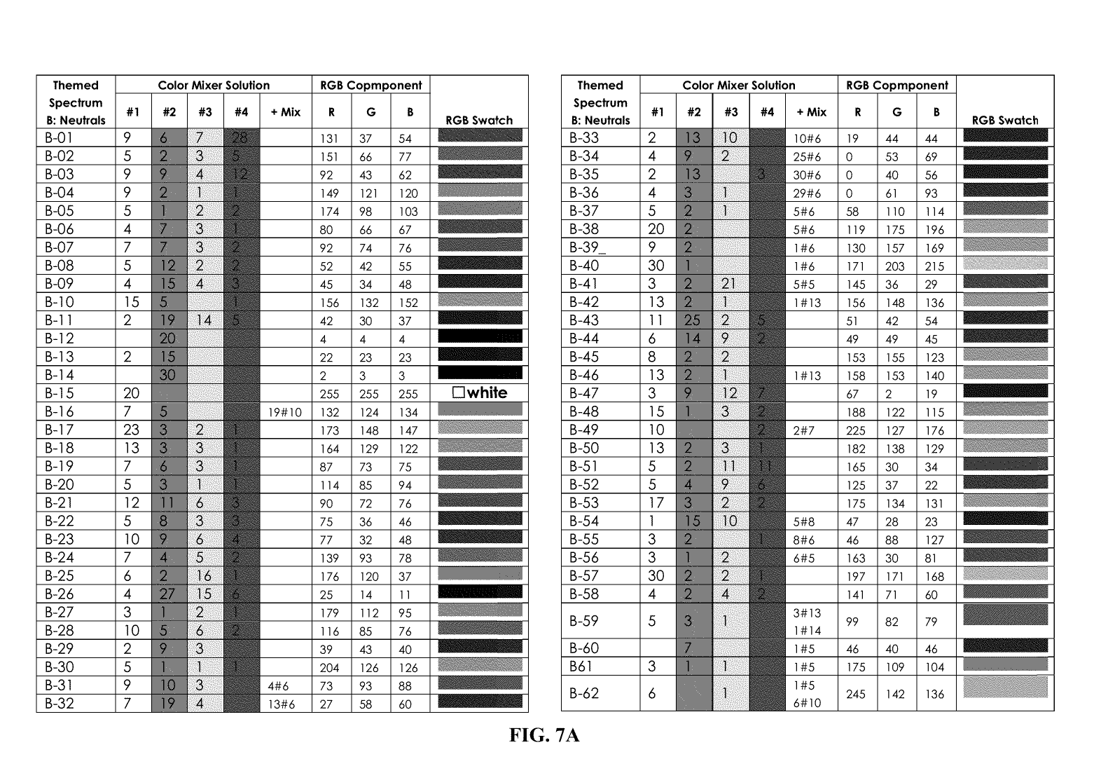

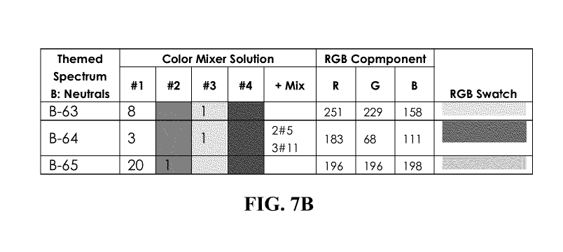

From the base polish and color mixer solutions described above and as shown in FIG. 4 with a 10 mL nail polish container containing 7.75 mL Un-colored base polish, a container containing color mixer solution #1, a container containing color mixer solution #2, a container containing color mixer solution #3, and a container containing color mixer solution #4. Each of the color mixer solutions is provided with a dropper of uniform size and shape to deliver uniform drops from one solution to the next. FIGS. 7A-7B depict a table depicting the themed spectrum and some of the colors achievable from this kit. The chart shows the relative number of drops of each color mixer solution to be added to the base polish to achieve the desired final nail polish color. Interestingly, in this kit, the color mixer solution colors are essentially white, black, orange, yellow, and red (using the most generic color terms for simplicity) yet result in colors such as pinks, reds, and rusts, but also some unexpected colors given the starting colors.

It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on.

Themed Spectrum C: Corals and Light Reds

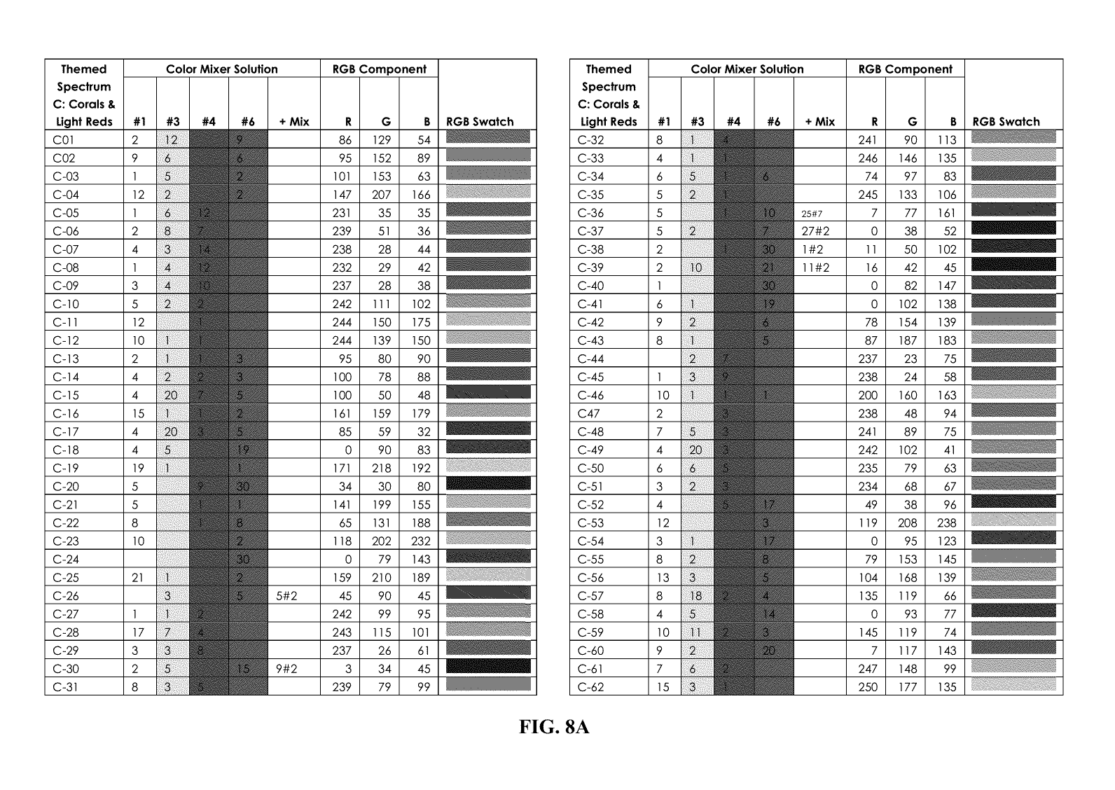

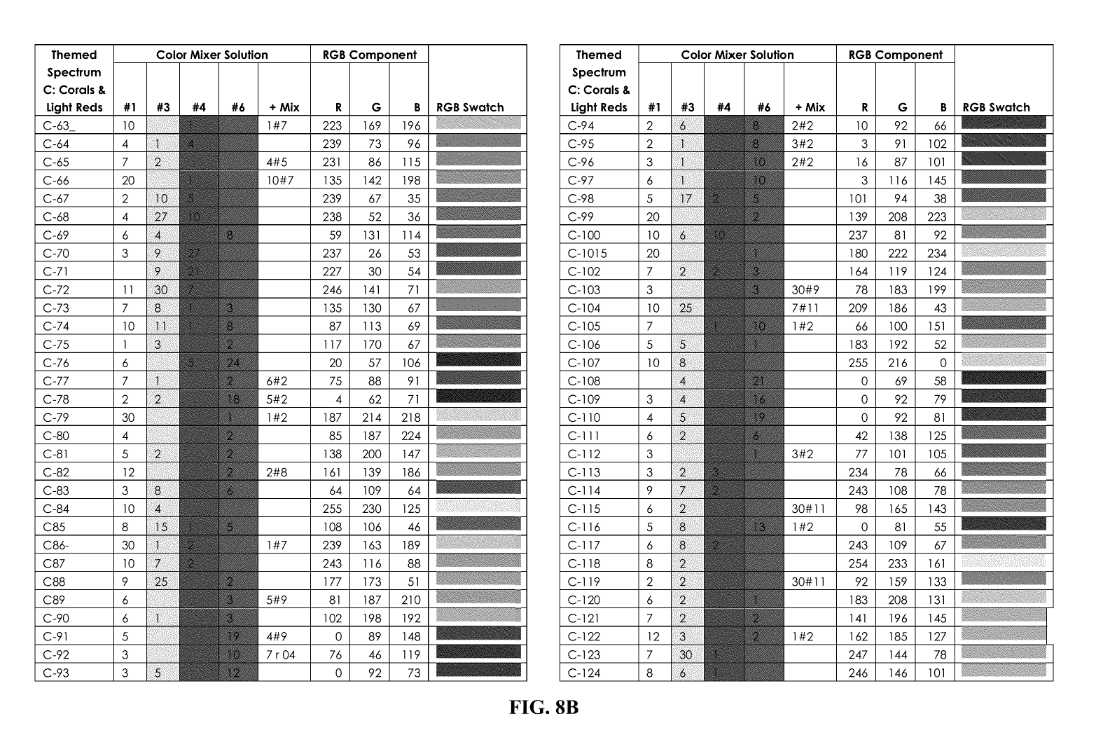

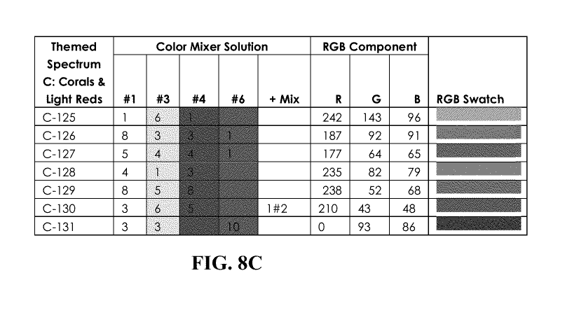

From the base polish and color mixer solutions described above, a kit is provided, as shown in FIG. 4, with a 10 mL nail polish container containing 7.75 mL Un-colored base polish, a container containing color mixer solution #1, a container containing color mixer solution #3, a container containing color mixer solution #4, and a container containing color mixer solution #6. Each of the color mixer solutions is provided with a dropper of uniform size and shape to deliver uniform drops from one solution to the next. FIGS. 8A-8C depict a table depicting the themed spectrum and some of the colors achievable from this kit. The chart shows the relative number of drops of each color mixer solution to be added to the base polish to achieve the desired final nail polish color.

It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on.

Themed Spectrum R: Clean Reds (in the Red)

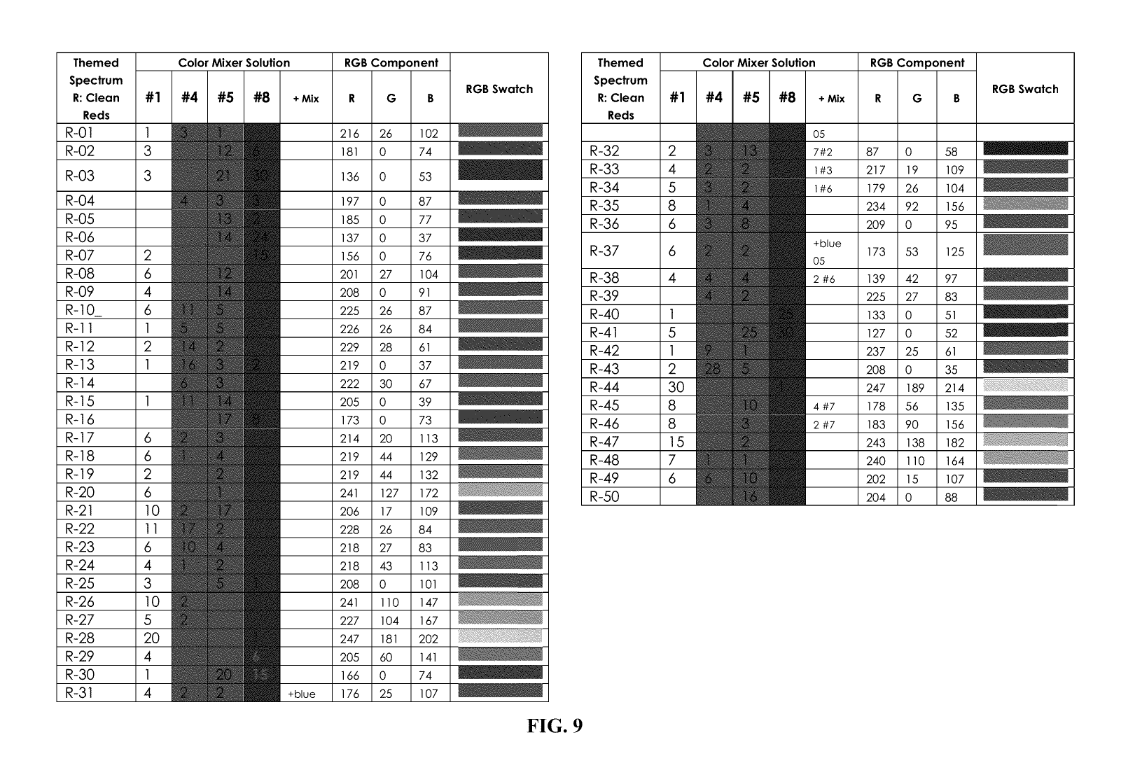

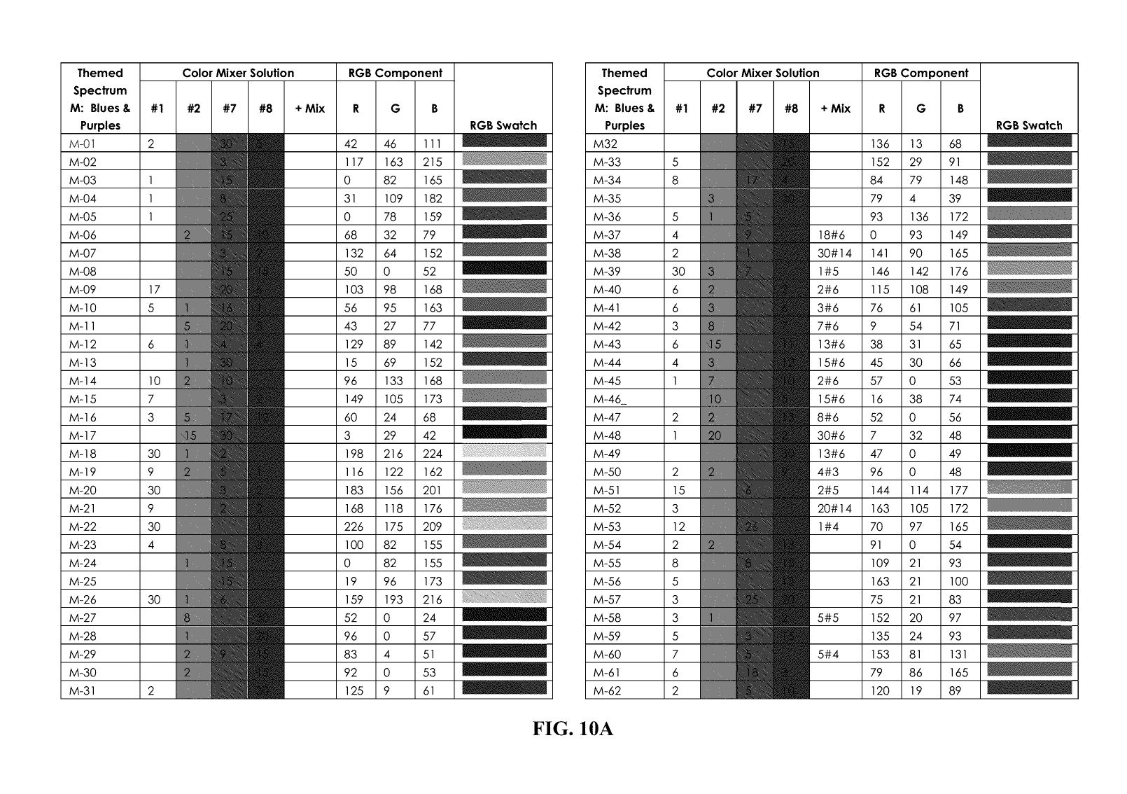

From the base polish and color mixer solutions described above, a kit is provided, as shown in FIG. 4 with a 10 mL nail polish container containing 7.5 mL Un-colored base polish, a container containing color mixer solution #1, a container containing color mixer solution #4, a container containing color mixer solution #5, and a container containing color mixer solution #8. Each of the color mixer solutions is provided with a dropper of uniform size and shape to deliver uniform drops from one solution to the next. FIG. 9 is a table depicting the themed spectrum and some of the colors achievable from this kit. The chart shows the relative number of drops of each color mixer solution to be added to the base polish to achieve the desired final nail polish color. It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on.

Themed Spectrum M: Blues and Purples (Moody Hues)

From the base polish and color mixer solutions described above, a kit is provided, as shown in FIG. 4, with a 10 mL nail polish container containing 7.75 mL Un-colored base polish, a container containing color mixer solution #1, a container containing color mixer solution #2, a container containing color mixer solution #7, and a container containing color mixer solution #8. Each of the color mixer solutions is provided with a dropper of uniform size and shape to deliver uniform drops from one solution to the next. FIGS. 10A-10B is a table depicting the themed spectrum and some of the colors achievable from this kit. The chart shows the relative number of drops of each color mixer solution to be added to the base polish to achieve the desired final nail polish color. Interestingly, in this kit, the color mixer solution colors are essentially white, black, blue, and violet (using the most generic color terms for simplicity) yet result in colors such as blues, purples, browns, and blacks, but also shades of pink and green, which does not seem possible given the starting colors, yet these colors have been made.

It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on.

Themed Spectrum X: Mica Shimmer (on the Rocks)

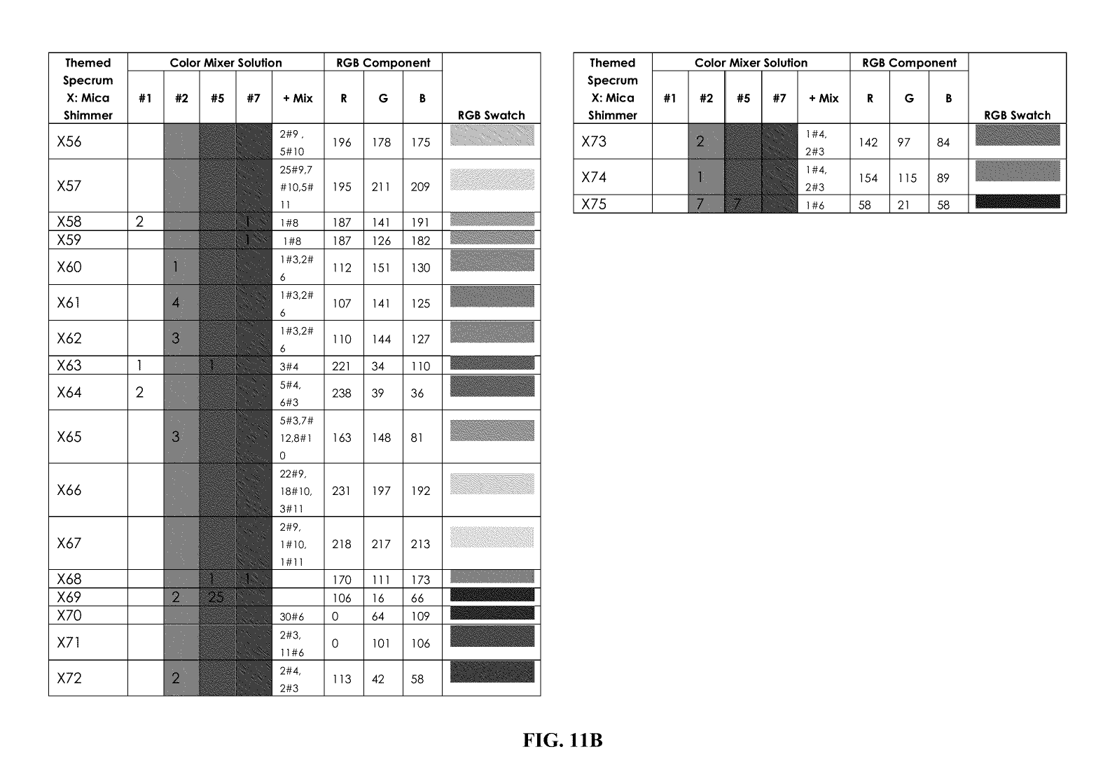

From the mica base polish and color mixer solutions described above, a kit is provided, as shown in FIG. 4 with a 10 mL nail polish container containing 7.5 mL Un-colored base polish, a container containing color mixer solution #1, a container containing color mixer solution #2, a container containing color mixer solution #5, and a container containing color mixer solution #7. Each of the color mixer solutions is provided with a dropper of uniform size and shape to deliver uniform drops from one solution to the next. FIGS. 11A-11B depict a table depicting the themed spectrum and some of the colors achievable from this kit. The chart shows the relative number of drops of each color mixer solution to be added to the base polish to achieve the desired final nail polish color. Interestingly, in this kit, the color mixer solution colors are essentially white, black, red, and blue (using the most generic color terms for simplicity) yet result in colors such as pinks, reds, blues, blacks, and purples, but also shades of green and yellow/gold, which does not seem possible given the starting colors, yet these colors have been made.

It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on. Finally, through altering the composition of any of the color mixer solutions, additional colors may be achieved, the palettes, spectrums, and individual color mixer solution colors are intended to be exemplary.

Themed Color Spectrum T: Tan Based

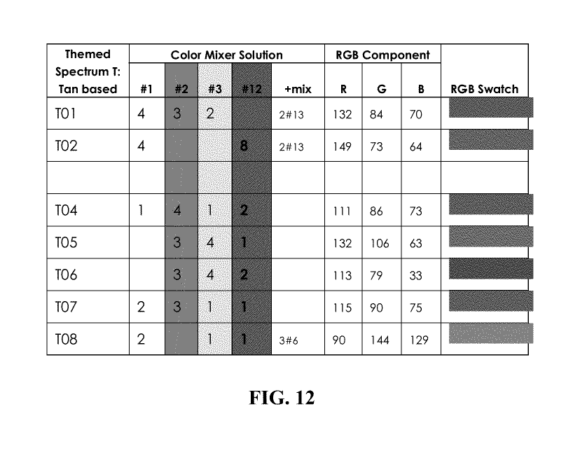

From the un-colored base polish and color mixer solutions described above, a kit is provided, as shown in FIG. 4 with a 10 mL nail polish container containing 7.5 mL Un-colored base polish, a container containing color mixer solution #1, a container containing color mixer solution #2, a container containing color mixer solution #3, and a container containing color mixer solution #12. Each of the color mixer solutions is provided with a dropper of uniform size and shape to deliver uniform drops from one solution to the next. FIG. 12 depict a table depicting the themed spectrum and some of the colors achievable from this kit. The chart shows the relative number of drops of each color mixer solution to be added to the base polish to achieve the desired final nail polish color. Interestingly, in this kit, the color mixer solution colors are essentially white, black, red, and blue (using the most generic color terms for simplicity) yet result in colors such as pinks, reds, blues, blacks, and purples, but also shades of green and yellow/gold, which does not seem possible given the starting colors, yet these colors have been made.

It should be readily recognized that additional colors or variations of these colors are possible by manipulating the relative proportions (drops) of each of the color mixer solutions. Additionally, as described above, additional colors are possible by adding a fifth, optional color mixer solution. The additional color mixer solution may be provided in the kit, or made available as an add-on. Finally, through altering the composition of any of the color mixer solutions, additional colors may be achieved, the palettes, spectrums, and individual color mixer solution colors are intended to be exemplary.

A different look for each of these collections can be achieved simply by swapping the plain base for the mica base to achieve a metallic/shimmer look or swapping the mica base for the plain base to achieve a standard “cream” look. Additional top or finish coats may also be employed.

This system, employing a relatively small number of color mixer solutions, even in the full series, and simple dropwise mixing recipes make this system amenable to computer or software driven applications whereby the recipe or instructions can be easily displayed or calculated based upon preset color recipes or from an acquired color. Such systems, software, applications, and network systems are described in a patent application filed concurrently herewith, noted as attorney docket no. 142506.00101, which is hereby incorporated by reference in its entirety.

In some embodiments, one or more nail polish kits may be used along with the mobile device applications and websites to create a variety of nail polish colors, either custom or to match a color in a pre-established color spectrum. Each nail polish kit may include a base polish solution and a plurality of different color mixer solutions which may be combined to create different nail polish colors.

What is claimed is:

1. A system for user-customizable nail polish, the system comprising:
at least one base nail polish container comprising a standard-sized container, wherein each base nail polish container is only partially filled with a base nail polish;
three or more color mixer solution containers, each having a uniform delivery device capable of delivering a standardized drop, and wherein each color mixer solution container contains a color mixer solution, selected such that a range of mixed nail polish colors are achievable by selectively mixing 1-40 standardized drops of each of at least two of the three or more color mixer solutions with the base polish wherein each color mixer solution has a known color contribution per drop.

2. (canceled)

3. The system of claim 1, wherein each of the at least one base polish is independently selected from an un-colored base polish, a colored base polish, and a mica base polish.

4. The system of claim 1, wherein each of the at least one base nail polish and each of the color mixer solutions are acetate based.

5. (canceled)

6. The system of claim 1, wherein the uniform delivery device is an eye dropper or a dropper nozzle tip.

7. The system of claim 1, wherein the uniform delivery device is standardized to 18-26 drops per mL of water.

8. The system of claim 1, further comprising one or more of a texturizer and a top coat.

9. The system of claim 1, further comprising instructions including information including which of the three or more color mixer solutions are required, and how many drops of each required color mixer solution is needed to achieve a known color.

10. A user customizable nail polish kit, the kit comprising:
a base polish comprising a suspension agent, in a nail polish container, wherein the nail polish container is only partially filled with a base nail polish;
a first color mixer solution to be selectively added to the nail polish container;
a second color mixer solution to be selectively added to the nail polish container;
a third color mixer solution to be selectively added to the nail polish container;
a fourth color mixer solution to be selectively added to the nail polish container;
wherein a uniform delivery device capable of delivering a standardized drop is provided for each color mixer solution; and
a themed spectrum recipe card containing information describing a spectrum of pre-established nail polish colors obtainable by mixing two or more of the first color mixer solution, second color mixer solution, third color mixer solution, fourth color mixer solution, and the base polish, and instructions for achieving each of the spectrum of pre-established colors.

11. The user customizable nail polish kit of claim 10, wherein:
the base polish is an un-colored base polish;
the first color mixer solution is color mixer solution #1, which comprises titanium dioxide;
the second color mixer solution is color mixer solution #9, which comprises Yellow 5 Lake;
the third color mixer solution is color mixer solution #10, which comprises Red 6 Lake;
the fourth color mixer solution is color mixer solution #11, which comprises Ferric ammonium ferrocyanide.

12. The user customizable nail polish kit of claim 10, wherein:
the base polish is an un-colored base polish;
the first color mixer solution is color mixer solution #1, which comprises titanium dioxide;
the second color mixer solution is color mixer solution #3, which comprises Yellow 5 Lake;
the third color mixer solution is color mixer solution #4, which comprises Red 6 Lake;
the fourth color mixer solution is color mixer solution #6, which comprises Ferric ammonium ferrocyanide.

13. The user customizable nail polish kit of claim 10, wherein:
the base polish is an un-colored base polish;
the first color mixer solution is color mixer solution #1, which comprises titanium dioxide;
the second color mixer solution is color mixer solution #4, which comprises Red 6 Lake;
the third color mixer solution is color mixer solution #5, which comprises Red 7 Lake;
the fourth color mixer solution is color mixer solution #8, which comprises Red 34 Lake.

14. The user customizable nail polish kit of claim 10, wherein:
the base polish is an un-colored base polish;
the first color mixer solution is color mixer solution #1, which comprises titanium dioxide;
the second color mixer solution is color mixer solution #2, which comprises Black 2;
the third color mixer solution is color mixer solution #7, which comprises Ultramarines;
the fourth color mixer solution is color mixer solution #8, which comprises Red 34 Lake.

15. The user customizable nail polish kit of claim 10, wherein:
the base polish is a mica base polish;
the first color mixer solution is color mixer solution #1, which comprises titanium dioxide;
the second color mixer solution is color mixer solution #2, which comprises Black 2;
the third color mixer solution is color mixer solution #5, which comprises Red 7 Lake;
the fourth color mixer solution is color mixer solution #7, which comprises Ultramarines.

16. The user customizable nail polish kit of claim 10, wherein:
the base polish is an un-colored base polish;
the first color mixer solution is color mixer solution #1, which comprises titanium dioxide;
the second color mixer solution is color mixer solution #2, which comprises Black 2;
the third color mixer solution is color mixer solution #7, which comprises Ultramarines;
the fourth color mixer solution is color mixer solution #4, which comprises Red 6 Lake.

17. The user customizable nail polish kit of claim 10, further comprising any of one or more additional color mixer solutions, one or more additional themed color spectrum recipe cards, and one or more additional color recipes.

18. The user customizable nail polish kit of claim 10, wherein each of the color mixer solutions is housed in its own container, each color mixer solution container being provided with a uniform drop delivery device.

19. The user customizable nail polish kit of claim 18, wherein each uniform drop delivery device is an eye dropper or a dropper nozzle tip.

20. The user customizable nail polish kit of claim 18, wherein each uniform drop delivery device delivers a known quantity of color mixer solution, and each drop has a known color contribution.
